(19) United States
(12) Patent Application Publication
(10) Pub. No.: US 2010/0185507 A1
(43) Pub. Date: Jul. 22, 2010

(54) METHOD AND SYSTEM FOR GENERATING AN ADVERTISEMENT WITH CUSTOMIZED CONTENT

(76) Inventor: LANCE TOKUDA, Foster City, CA (US)

Correspondence Address: Raj Abhyanker LLP, 1580 West, El Camino Real, Suite 8, Mountain View, CA, 94040, US

(21) Appl. No.: 12/356,520

(22) Filed: Jan. 20, 2009

Related U.S. Application Data
(60) Provisional application No. 61/145,759, filed on Jan. 20, 2009.

(51) Int. Cl. G06Q 30/00; G06Q 90/00

(52) U.S. Cl. 705/14.41; 705/14.66; 705/319

(57) ABSTRACT

An exemplary embodiment provides a computer-implemented method of online marketing. In a server, a node x of a social graph linked to a node y of the social graph is identified through a tie λ comprising a behavior μ of the node y with the social networking website and a profile information μ of the node y with the social networking website. An advertisement relevant to the tie λ is determined. A design α is applied to the advertisement through an algorithmic analysis in the server of the tie λ. A characteristic of the node y is algorithmically integrated into the advertisement. The advertisement is displayed on a webpage accessible by node x.

### PRIORITY CLAIM

This application claims the benefit of U.S. Provisional Application No. 61145759, filed on Jan. 20, 2009, titled ‘A METHOD AND SYSTEM FOR GENERATING AN ADVERTISEMENT WITH CUSTOMIZED CONTENT’. This application is incorporated herein by reference.

### FIELD OF TECHNOLOGY

This disclosure relates generally to online marketing and more particularly to syndication of a customized advertisement.

### BACKGROUND

A vendor may publish an advertisement on a web page and/or application of a social networking website. The advertisement may include a hyperlink pointing to a commercial website of the vendor. The vendor may design the advertisement to appeal to a general class of people. An individual member may not relate to the design. Consequently, the individual member may not find the advertisement interesting. The member may not click on the advertisement. Thus, the member may not purchase a product of the vendor. The vendor may not increase a number of page views of the commercial website. As a result, the vendor may lose revenue.

### SUMMARY

Several methods and a system for generating an advertisement with customized content are disclosed.

An exemplary embodiment provides a computer-implemented method of online marketing. In a server, a node x of a social graph linked to a node y of the social graph is identified through a tie λ comprising a behavior μ of the node y with the social networking website and a profile information μ of the node y with the social networking website. An advertisement relevant to the tie λ is determined. A design α is applied to the advertisement through an algorithmic analysis in the server of the tie λ. A characteristic of at least one of the node x and the node y is algorithmically integrated into the advertisement. A content of a webpage of the social networking website associated with the node x is updated to comprise the advertisement.

An action of the node x is monitored with respect to the advertisement to determine a value of the advertisement. Another tie λ′ is determined if the value of the advertisement is below a specified threshold. Another tie λ′ comprises a behavior μ′ of the node y with the social networking website and a profile information μ′ of the node y with the social networking website. The tie λ′ is relevant to the advertisement. A design α′ is applied to the advertisement through an algorithmic analysis in the server of the tie λ′ if the value of the advertisement is below the specified threshold. Another characteristic of at least one the node x and the node y is integrated into the advertisement if the value of the advertisement is below the specified threshold.

An exemplary embodiment provides a computer-implemented method of online marketing. A social graph associated with a social networking website is analyzed to determine a relationship between a user and an entity that is relevant to an advertisement. The relationship is based on, inter alia, an action and profile information of the entity. The relationship may also be based on, inter alia, an action and profile information of the user. A design is applied to an advertisement through an algorithmic analysis in a computer through an action and a profile information of at least one of the entity. A characteristic of the entity is inserted into the advertisement. A webpage of the social networking website accessed by the user is algorithmically updated to display the advertisement.

An exemplary embodiment provides a system of an advertisement syndication targeting server. The system includes an advertisement syndication targeting server and a database associated with the advertisement syndication targeting server. The system also includes a social graph analyzer associated with the advertisement syndication targeting server to identify a node x of a social graph linked to a node y of the social graph through a tie λ comprising a behavior μ of the node y with the social networking website and a profile information μ of the node y with the social networking website.

In addition, the system includes a targeter module associated with the advertisement syndication targeting server to determine an advertisement relevant to the tie λ and a design creator to apply a design α to the advertisement through an algorithmic analysis in the server of the tie λ. The system includes an advertisement configurator to algorithmically integrate a characteristic of the node x and the node y into the advertisement. The system includes an update module to update a content of a webpage of the social networking website associated with the node x to comprise the advertisement.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying Drawings and from the Detailed Description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 is a systematic view illustrating a user communicating to the social networking provider server, according to one embodiment.

FIG. 2 is an exploded view of an advertisement syndication server, according to one embodiment.

FIG. 3 is a diagrammatic view of a graphical user interface illustrating a web page of a social networking website, according to one embodiment.

FIG. 4 is a tabular view illustrating details of an identified node and the list of relevant advertisements, according to one embodiment.

FIG. 5 is a diagrammatic view illustrating a tie λ that links X and the node Y associated with the social networking website, according to one embodiment.

FIG. 6 is a diagrammatic view illustrating another tie λ′ that links X and the node Y associated with the social networking website, according to one embodiment.

FIG. 7 is a diagrammatic system view of a data processing system in which any of the embodiments disclosed herein may be performed, according to one embodiment.

FIG. 8A is a process flow illustrating the identification of nodes and deriving the social graph from the record of usage available on the social networking website, according to another embodiment.

FIG. 8B is a continuation of process flow illustrated in FIG. 8A showing additional embodiments, according to another embodiment.

FIG. 9 is a process flow that illustrates analysis of a social graph associated with a social networking website and updating the webpage accessed by the user to indicate the various elements based on the social graph, according to yet another embodiment.

FIG. 9B is a continuation of process flow illustrated in FIG. 9A showing additional embodiments, according to yet another embodiment.

Other features of the present embodiments will be apparent from the accompanying Drawings and from the Detailed Description that follows.

### DETAILED DESCRIPTION

Several methods and a system to generate an advertisement with customized content are disclosed.

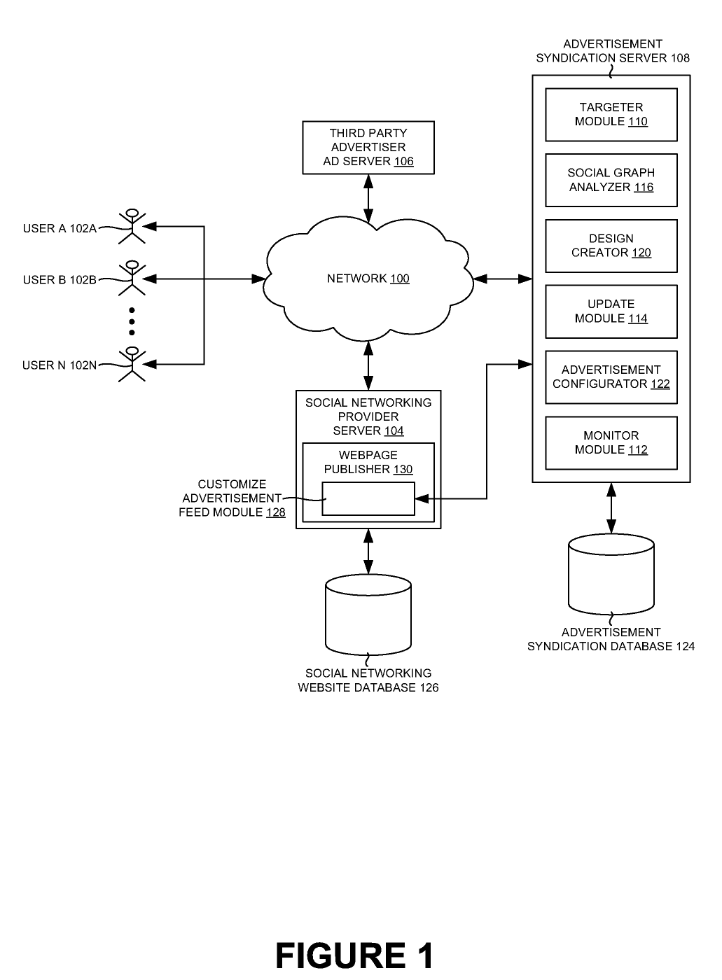

FIG. 1 is a systematic view illustrating a user communicating to the social networking provider server. Particularly FIG. 1 illustrates a network 100, a user A-N 102A-N, a social networking provider server 104, a third party advertiser server 106, an advertisement syndication server 108, a target module 110, a monitor module 112, an update module 114, a social graph analyzer 116, a design creator 120, an advertisement configurator 122, an advertisement syndication database 124, a social networking website provider database 126, a customized advertisement feed module 128 and a web page publisher 130, according to one embodiment.

In an example embodiment, the user A-N 102A-N may communicate with the third party advertiser ad server 106, the social networking provider server 104, and the advertisement syndication server 108 through the network 100. The social networking provider server 104 may include a web page publisher 130. The web page publisher may include a customize advertisement feed module 128. The customize advertisement feed module 128 may communicate with the advertisement syndication server 108. The customize advertisement feed module 128 may communicate with the social networking website provider database 126. The advertisement syndication server 108 may include a targeter module 110, a social graph analyzer 116, a design creator 120, an update module 114, an advertisement configurator 122 and a monitor module 112. The advertisement syndication server 108 may communicate with the advertisement syndication server database 124.

The user A-N 102A-N may be a member of a social networking website supported by the social networking provider server 104. The social networking website may be a free-access networking website. The user A-N 102A-N may be able to join networks organized by city, workplace, school, and region to connect and interact with other people. The user A-N 102A-N may also be able to associate and add friends. The user A-N 102A-N may be able to send messages to other members. The user A-N 102A-N may be able to operate an instant messaging application to a form of real-time communication online with other members using a typed text. The user A-N 102A-N may be associated with a personal profile that is displayed on a webpage 300 of the social networking website.

The third party advertiser ad server 106 may be a web server that is dedicated to running software applications for advertisements used in online marketing. The advertisement may include a navigation element (e.g. a hyperlink) that allows the user A-N 102A-N to navigate to the website of a third-party vendor. The third party Advertiser Ad server 106 may delivers the advertisements to websites supported by the social networking provider server 104 (e.g. the personal profile homepage 300). A third party may utilize the third party advertiser ad server 106 to provide software to the social networking provider server to serve, monitor and provide a syndicated advertisement appearing on a personal profile homepage 300. In other embodiments, the third party advertiser ad server 106 may choose the advertisements that may be optimized for the social networking provider. The advertisements may be algorithmically targeted to specified members, networks of the social networking website.

The social networking provider server 104 may provide a platform for a social network service of the social networking website to build online communities of users who share interests and/or activities. The users may be interested in exploring the interests and activities of others. The social network may be web based and provide a variety of ways for users to interact, such as e-mail and/or instant messaging services. The social network may be included in a social graph of the social networking website. The social networking provider server 104 may restrict access only to a private network that may include the user A-N 102A-N and those provided permission by the user. The social networking provider server 104 may also include a web page publisher 130. The web page publisher 130 may publish web pages associated with the social networking website on the World Wide Web. The web page publisher 130 may use the customize advertisement feed module 128 to allow the third party advertiser ad server 106 to provide syndicated advertisement content to web pages associated with the social networking website. The web page publisher 130 may also be used to allow the advertisement syndication server 108 to modify and integrate additional content to the syndicated advertisement content. The third party social networking website provider database 126 may store data related to the functioning of the social networking provider server.

The advertisement syndication server 108 may be a server dedicated to running software applications and functionalities related to developing, publishing and customizing targeted advertisements on the social networking website.

The social graph analyzer 116 may algorithmically analyze a social graph to identify a node x of a social graph linked to a node y of the social graph through a tie λ comprising at least one of a behavior μ of the node y with the social networking website and a profile information β of the node y with the social networking website. In another embodiment, the tie λ may also comprise a behavior β of the node x with a social networking website, a profile information β of the node x with the social networking website. In yet another embodiment the social graph analyzer 116 may also determine another tie λ′ comprising at least one of a behavior β′ of the node x with the social networking website, a profile information β of the node x with the social networking website, a behavior μ′ of the node y with the social networking website and a profile information μ′ of the node y with the social networking website if the value of the advertisement is below a specified threshold, and wherein tie λ′ is relevant to the advertisement.

The social graph may be a structure used for the representation (and implementation) of a social network. The social network may be a social structure made of nodes that are tied by one or more specific types of interdependency, such as values, visions, ideas, financial exchange, friendship, kinship, dislike, conflict and/or trade. A node may be a user A-N 102A-N. In other embodiments, a node may be a guest and/or an organization. A node may be an individual actor within the social network. A tie may be a relationship and/or a set of relationships between two nodes. The social graph analyzer 116 may represent the social graph as a mathematical abstraction in order to analyze the social graph according various metrics of social graph analysis. A metric of analysis may include analyzing the extent to which a node lies between other nodes in the social graph of the social network. This may include the connectivity of the node's neighbors, giving a higher value for nodes which bridge clusters. The measure may reflect the number of people a person is connecting indirectly through a direct link.

Another metric of analysis may include the difference between the number of links for each node divided by maximum possible sum of differences. For example, a centralized network will have many of its links dispersed around one or a few nodes, while a decentralized network is one in which there is little variation between the number of links each node possesses. Another metric of analysis may include the degree to which an individual is near all other individuals in a network (directly or indirectly). It reflects the ability to access information through the “grapevine” of network members. Thus, closeness is the inverse of the sum of the shortest distances between each individual and every other person in the network. Another metric of analysis may include the extent to which nodes have a common set of linkages to other nodes in the system. Another metric of analysis may include the degree to which any member of a network can reach other members of the network. Another metric of analysis may include the degree an individual's network reaches out into the network and provides novel information and influence. Another metric of analysis may include the distances between pairs of nodes in the network. Another metric of analysis may include a node's centrality as a standard of prestige within the network (e.g. degree prestige). Still other metrics of analysis may be used to analyze the social graph that are not explicitly disclosed herein.

The social graph analyzer 116 may analyze a social graph associated with a social networking website to determine a relationship between a user and an entity that is relevant to an advertisement. The relationship may be based on at least one of an action and a profile information of the entity. In another embodiment, the relationship may also comprise an action and a profile information of the user as well. The user and the entity may be nodes of the social network. In a particular embodiment, the user and entity may be respective nodes of a social graph of the social networking website.

The targeter module 110 may analyze a set of advertisements provided by the third party advertiser ad server 106. The targeter module 110 may associate a particular advertisement with a particular user based on various traits of the user such as demographics, purchase history, or observed behavior and various relevant contents of the advertisement such as products, prices and designs. In a particular embodiment, the targeter module 110 may determine an advertisement relevant to the tie λ.

The design creator 120 may be a software application that applies a design α to the advertisement through an algorithmic analysis in the advertisement syndication server 108 of the tie λ. For example, the social graph analyzer 116 may have analyzed a set of relationships between two users A-N 102A-N. The social graph analyzer 116 may provide the data to the design creator 120. This data may then be utilized by the design creator 120 to algorithmically modify the design of the advertisement provided to the advertisement syndication server 108 (to further target the advertisement to a specified user). For example, the design creator 120 may utilize the data to algorithmically change a dominant color scheme of a design to a preferred color of at least of user A 102A and user B 102B. In another embodiment, the design creator 120 may also apply a design α′ to the advertisement through an algorithmic analysis in the server of the tie λ′ if the value of the advertisement is below the specified threshold. In other embodiments, the design creator 120 may be integrated with the advertisement configurator 122.

The advertisement configurator 122 may be a software application that integrating a characteristic of at least one of the node x and the node y into the advertisement. For example, the advertisement configurator 122 may utilize data provided the social graph analyzer 116 gained by analyzing a set of relationships between two users A-N 102A-N. This data may then be utilized by advertisement configurator 122 to algorithmically integrate a characteristic of at least one user A 102A and user B into the advertisement. For example, the analysis of the relationship between user A 102 A and user B 102B may indicate a preference for a particular actor. The actor's voice may be chosen as the voice over source for the advertisement. At least one user A 102A and user B 102B's faces may appear in the advertisement as well. At least one user A 102A and user B 102B's names may appear in the advertisement. A past behavior of at least one user A 102A and user B 102B may also be referred to in the advertisement. For example, a recent purchase, acquiring a particular social networking application or joining a particular social networking group may be mentioned in the advertisement.

The advertisement configurator 122 algorithmically integrates a characteristic of at least one of the node x and the node y into the advertisement. The advertisement configurator 122 may integrate another characteristic of at least one of the node x and the node y into the advertisement if the value of the advertisement is below the specified threshold. The advertisement configurator 122 may integrate at least one of an image, a user name, an audio file, a video and a text associated with the node x into the advertisement. The advertisement configurator 122 may integrating at least one of another image, a name of the member, another audio file, another video and another associated with the node y into the advertisement. The advertisement configurator 122 may integrate a facial image of at least one of the node x and the node y into the advertisement. The advertisement configurator 122 may integrate another characteristic of at least one of the node x and the node y into the advertisement if the value of the advertisement is below the specified threshold.

In another embodiment, the advertisement configurator 122 may algorithmically incorporate at least one of a user characteristic and an entity characteristic into the advertisement. The characteristic may be at least one of an image associated with at least one of the user and the entity, a text associated with at least one of the user and the entity, an audio file associated with at least one of the user and the entity, and a video associated with at least one of the user and the entity.

The update module 114 may be a software application that updates the content of a webpage of the social networking website associated with the node x to comprise the advertisement. The update module 114 may algorithmically update the webpage of the social networking website accessed by the user to indicate the user's name. The update module 114 may algorithmically update the webpage of the social networking website accessed by the user to indicate an entity's name. The update module 114 may algorithmically update the webpage of the social networking website accessed by the user to indicate at least one of a historic behavior and a present behavior of the user. The update module 114 may algorithmically update the webpage of the social networking website accessed by the user to indicate at least one of a historic behavior and a present behavior of the entity. The update module 114 may algorithmically update the webpage of the social networking website accessed by the user to display a specified portion of a photograph comprising the user. The update module 114 may algorithmically update the webpage of the social networking website accessed by the user to display a specified portion of a photograph comprising at least one of the entity. The update module 114 may algorithmically update the webpage of the social networking website accessed by the user to display the specified portion of a photograph comprising a facial feature of the user. The update module 114 may algorithmically update the webpage of the social networking website accessed by the user to display the specified portion of a photograph comprising a facial feature of the entity.

The monitor module 112 may monitor an action of the node x with respect to the advertisement to determine a value of the advertisement. The value may be based on the number of times the user A 102A (e.g. node x) clicks on a particular customized advertisement per the number of times the particular customized advertisement is presented. In another embodiment, the value may be based on the number of page views a particular customized advertisement generates.

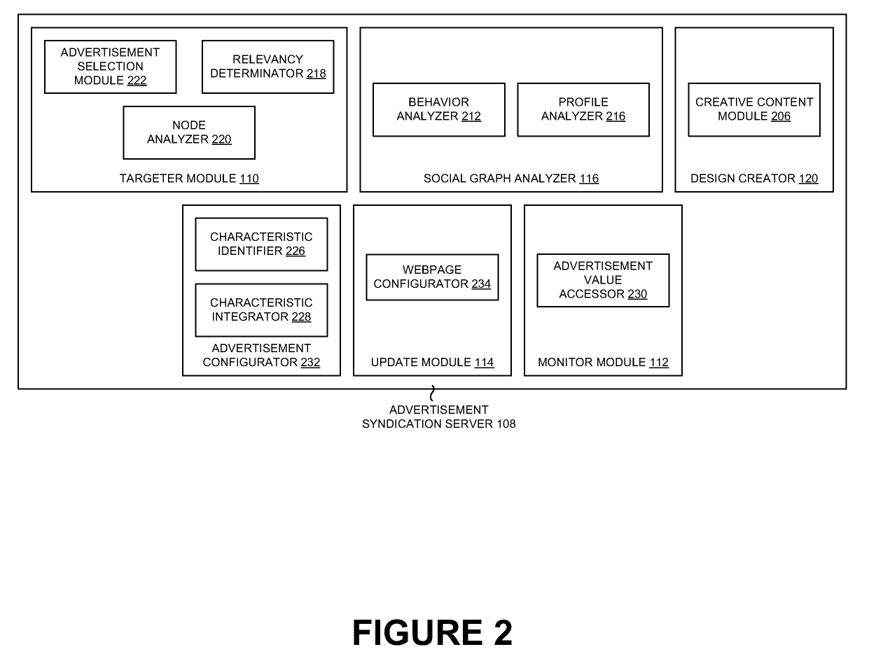

FIG. 2 is an exploded view of the advertisement syndication server 108. Particularly FIG. 2 illustrates a targeting module 200, an integrator module 204, a creative content module 206, a node identifier 210, a behavior analyzer 212, a profile analyzer 216, a relevancy determinator 218, a node analyzer 220, an advertisement selection module 222, an advertisement selection module 222, a tie analyzer 224, a characteristic identifier 226, a characteristic integrator 228, an advertisement value accessor 230, and an advertisement configurator 232, a web page configurator 234, according to one embodiment.

The targeter module 110 may include the advertisement selection module 222, a node identifier 210 and the relevancy determinator 218. The advertisement selection module 222 may match particular advertisement with the user A-N 102A-N. The node identifier 210 may identify the user A-N 102A-N (e.g. a node of a social network of the social networking website) as a possible match to a particular advertisement. This user may be identified as node x for purposes of later social graph analysis by the social graph analyzer 116. The relevancy determinator 218 may determine the relevancy of a particular advertisement to the user A-N 102A-N based on a historical action of the user A-N 102A-N or the user's profile information.

The social graph analyzer 116 may include may include the behavior analyzer 212 and the profile analyzer 216. The behavior analyzer 212 may algorithmically analyze a particular relationship (e.g. a tie) between to users A-N 102A-N (e.g. nodes) of the social network. This may include a historical behavior of a user A-N 102A-N. The behavior analyzer 212 may communicate data resulting from the analysis to other modules of the advertisement syndication server 108. The profile analyzer 216 may algorithmically analyze a set of data comprising profile information of a user A-N 102A-N of the social network. The profile analyzer 216 may communicate data resulting from the analysis to other modules of the advertisement syndication server 108.

The design creator 120 may include the creative content module 206. The creative content module 206 may determine and configure the creative design of the advertisement.

The advertisement configurator 232 may include a characteristic identifier 226 and the characteristic integrator 228. The characteristic identifier 226 may identify a particular relevant characteristic of the user A-N 102A-N. The characteristic integrator 228 may integrate the website into the creative aspect of the advertisement in a manner relevant to the content of the advertisement in order to optimize the attraction of the advertisement to the users A-N 102A-N.

The update module 114 may include webpage configurator 234. The webpage configurator 234 may configure a webpage of the social networking website accessed by any user A-N 102A-N.

The monitor module 112 may include the advertisement value accessor 230. The advertisement value accessor 230 may determine a value of the advertisement according to a specified metric.

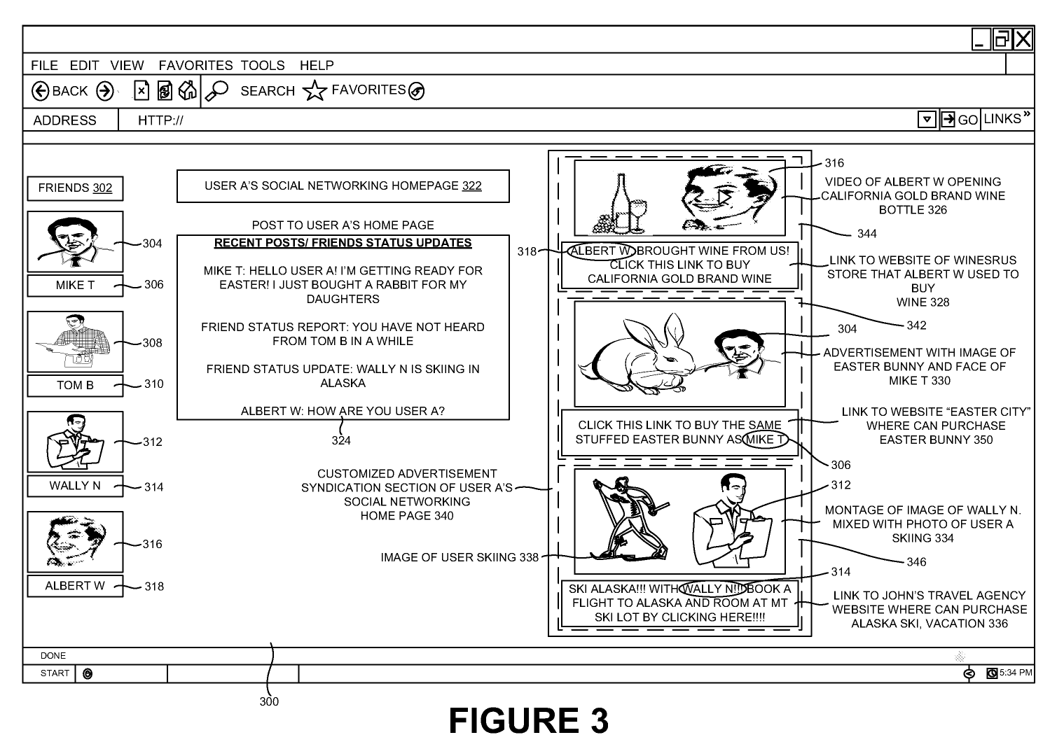

FIG. 3 is a diagrammatic view of a graphical user interface displaying a webpage 300 of the social networking website. A webpage 300 may be accessed by a user A 102A of a social networking website. A friends box 302 may illustrate the list of friends of the user A 102A who may be connected through the social networking website. An image 304 may display the image of Mike T. A label box 306 may display the name of the person whose image is displayed, for example Mike T. For example, the label box 306 may be integrated into the advertisement 320 to display the name of Mike T. in an Easter bunny advertisement 342. An image 308 may display the image of Tom B. A label box 310 may display the name Tom B. An image 312 may display the image of Wally N. A label box 314 may display the name Wally. An image 316 may display the image of Albert W. A label box 318 may display the name Albert W. A user A's social networking home page 322 includes separate section a customized advertisement syndication section of user A's social networking home page 340 that may include various advertisements for online marketing. The advertisements may include the images, links to the other websites and other details that may be useful for purchasing the products advertized therein. The webpage 300 may also include a section to illustrate posts to user A's homepage 324. The posts may include recent posts by friends within the social network or friend's status updates.

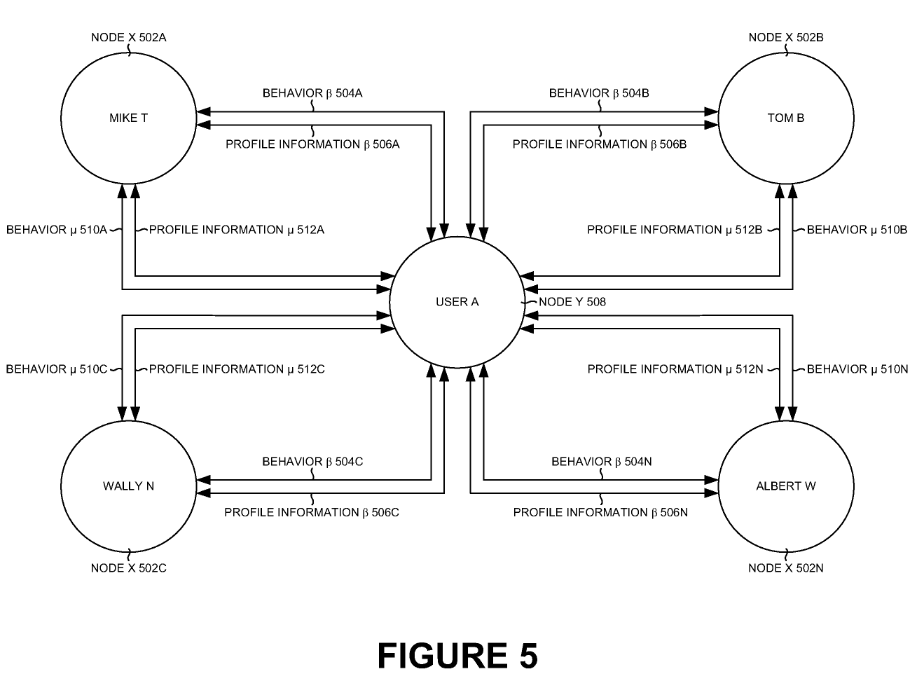

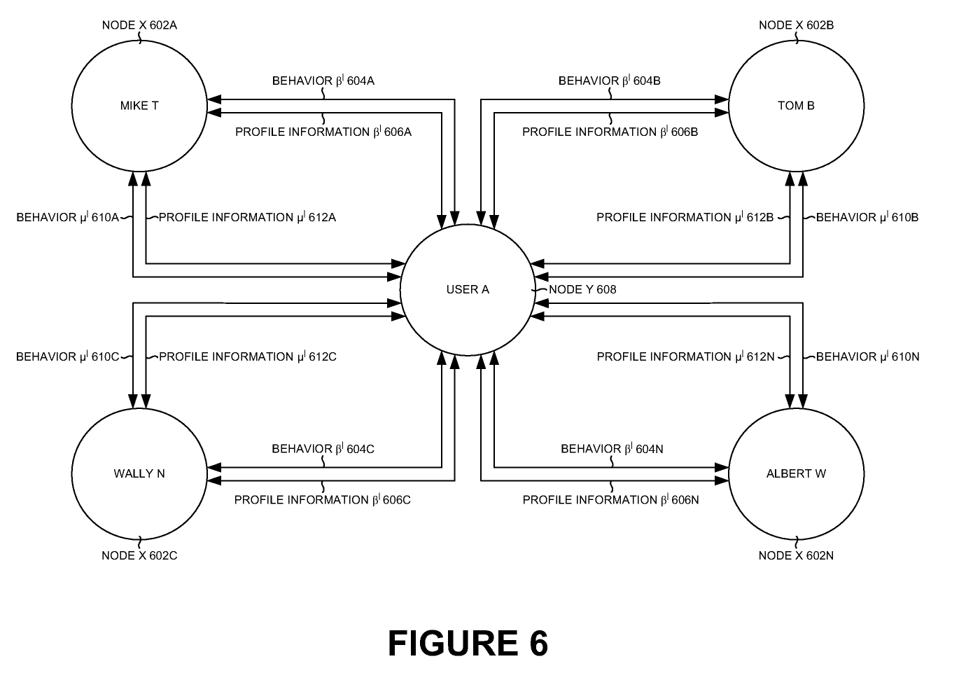

For example, the webpage 300 may be the homepage of user A 102A. The webpage 300 may display advertisements 342, 344, and 346 of the customized advertisement syndication section 340. The advertisements 342, 344, and 346 may link to different websites for online marketing. For example, advertisement 342 may include a hyperlink to allow the user A 102A to link to a website of Easter City where user A 102A can purchase an Easter bunny 350. Advertisement 344 may include a hyperlink to allow the user A 102A to link to a website of WINERUS store that Albert A. used to buy wine 328. Advertisement 346 may include a hyperlink to allow the user A 102A to link to John's Travel Agency website 336. User A 102A may be enabled to purchase an Alaska ski vacation at the John's Travel Agency website. The advertisement syndication server 106 may have targeted the advertisements 342, 344, and 346 to user A 102A based on a relevant relationship between user A 102A and a particular friend of user A within the social graph of the social networking website (e.g. the social graph of FIGS. 5 and 6). The advertisements 342, 344, and 346 may have been customized by the advertisement syndication server 106 to induce user A 102A to navigate to the particular third-party commercial website linked to within advertisements 342, 344, and 346. The customization may include names, actions and images of User A's 102A friends in the social graph of the social networking website. The advertisement syndication server 106 may utilize the methods and systems of the various embodiments illustrated in FIGS. 1-9B to render and display the advertisements 342, 344, and 346.

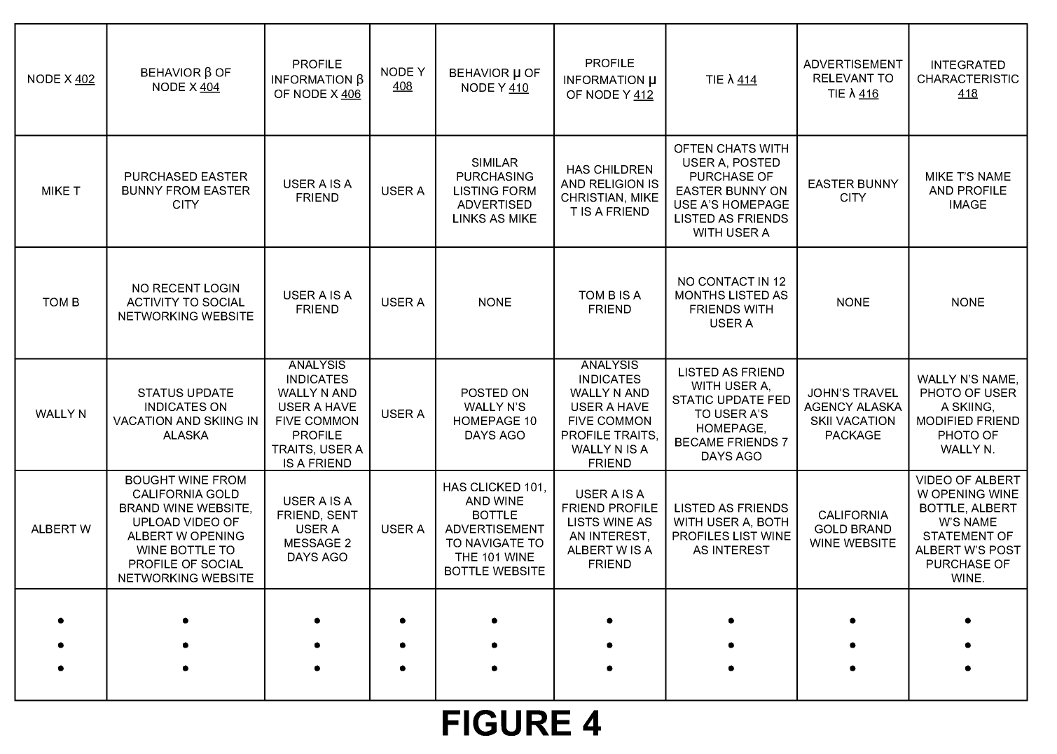

FIG. 4 is a tabular view illustrating details of an identified node and the list of relevant advertisements. In an example embodiment, the table illustrates a column identified node x 402, a column behavior β of node x 404, a column profile information β of node x 406, a column node y 408, a column behavior μ of node y 410, a column profile information μ of node y 412, a column tie λ 414, a column advertisement relevant tie λ 416 and a column integrated characteristic 418. The column identified node x 402 may include other users of the social networking website with a specified relationship with the node y 408. The column behavior β of node x 404 may exemplify the behavior of Mike T, Tom B, Wally N, and Albert W. The column profile information β of node x 406 may exemplify the profile information related to Mike T, Tom B, Wally N, and Albert W. The column node y 408 may illustrate the different users of node y. The column behavior μ of node y 410 may exemplify the behavior of the users relevant to node y. The column profile information μ of node y 412 may exemplify the profile information related to the users relevant to node y. The column advertisement relevant to tie λ 416 may include the advertisements that may be relevant to tie λ. The column integrated characteristic 418 may exemplify the characteristics that may be integrated into the advertisement. In another particular embodiment, the information of column behavior β of node x 404 and the information of column profile information β of node x 406 may not be used to determine advertisement relevant to tie λ 416.

FIG. 5 is a diagrammatic view illustrating a tie λ that links a node x 502A-N and a node y 508 according to a social graph of the social networking website. Particularly FIG. 5 illustrates a node x 502A-N, a behavior β 504A-N, a profile information β 506A-N, a behavior p 510A-N, the node y 508 and a profile information μ 512A-N, according to one embodiment.

In an example embodiment, the user A may be the node y may be linked to the node x 502A through the tie λ that may include the behavior β 504A, the profile information β 506A, the behavior μ 510A and the profile information μ 512A. The user A may be linked to the node x 502B through the tie λ that may include the behavior β 504B, the profile information β 506B, the behavior μ 510B and the profile information μ 512B. The user A may be linked to the node x 502C through the tie λ that may include the behavior β 504C, the profile information β 506C, the behavior μ 510C and the profile information μ 512C. The user A may be linked to the node x 502N through the tie λ that may include the behavior β 504N, the profile information β 506N, the behavior μ 510N and the profile information μ 512N. In another embodiment, the tie λ may only include the behavior μ 510A and the profile information μ 512A.

For example, in one particular embodiment, the social graph analyzer 116 may algorithmically analyze the social graph of FIG. 5 and identify Mike T a node x 502A. The social graph analyzer 116 may algorithmically analyze the social graph of FIG. 5 and identify User A as node y 508. The social graph analyzer 116 may algorithmically analyze the social graph of FIG. 5 and tie λ as comprising a behavior μ 510A of User A 508 with the social networking website and a profile information μ 512A of User A 508 with the social networking website. In one embodiment, the tie λ may also comprise a behavior β 504A of Mike T 502A with a social networking website, a profile information β 506A of Mike T 502A with the social networking website. The behavior β 504A of Mike T 502A with a social networking website may be purchasing Easter bunny from Easter City through a hyperlink found on the social networking website. The profile information β 506A of Mike T 502A may be that Mike T 502A is listed as a friend of User A 508. The behavior μ 510A of User A 508 may be a similar purchase as Mike T 502A from a particular advertisement that formerly appeared on the social networking website. The profile information μ 512A of User A 508 may be that User A 508 is listed as a friend of Mike T 502A.

Easter City may be a third party corporation that sells Easter bunnies. Easter City may operate a third party ad server 106. Easter City may communicate the Easter bunny advertisement 342 to the social networking provider server 104 in order for the Easter bunny advertisement 342 to be included on a webpage 300 published by the social networking provider server 104.

The targeter module 110 may analyze the Easter bunny advertisement 342 provided by the third party advertiser ad server 106. The targeter module 110 may associate the Easter bunny advertisement 342 with both User A and Mike T. The association may be based upon the traits of User A and Mike T (e.g. both User A and Mike T listed their religion as Christian and have children according to their profile information). For example, the association may be based upon information represented within tie λ such as behavior β 504A and behavior μ 510A.

The design creator 120 may apply a design α to customize the Easter bunny advertisement 342 through an algorithmic analysis of the tie λ. For example, User A's profile information may indicate that his favorite color is blue. The design creator may then include more blue in the creative design of the Easter bunny advertisement 342. The advertisement configurator 122 integrates the face, the name and the past action (purchased Easter bunny from Easter City) of Mike T 502A into the now customized Easter bunny advertisement 342. The update module 114 may then update a content of a webpage 300 of the social networking website associated with User A 508 to comprise the customized Easter bunny advertisement 342. The monitor module 112 may monitor an action of User A. The action may be whether User A 508 navigates to the Easter City website through the hyperlink located within the Easter bunny advertisement.

FIG. 6 is a diagrammatic view illustrating another tie λ′ that links node x and the node y according to a social graph of the social networking website. Particularly FIG. 6 illustrates a node x 562A-N, a behavior β′ 604A-N, a profile information β′ 606A-N, a behavior μ′ 610A-N, and a profile information μ′ 612A-N, according to one embodiment.

In an example embodiment, the user A of the node y may be linked to the node x 602A through the tie λ′ that may include the behavior β′ 604A, the profile information β′ 606A, the behavior μ′ 610A and the profile information μ′ 612A. The user A may be linked to the node x 602B through the tie λ′ that may include the behavior β 604B, the profile information β′ 606B, the behavior μ′ 610B and the profile information μ′ 612B. The user A may be linked to the node X 602C through the tie λ′ that may include the behavior β′ 604C, the profile information β′ 606C, the behavior μ′ 610C and the profile information μ′ 612C. The user A may be linked to the node x 602N through the tie λ′ that may include the behavior β′ 604N, the profile information β′ 606N, the behavior μ′ 610N and the profile information μ′ 612N. In another embodiment, the tie λ′ may only include the behavior μ′ 510A and the profile information μ′ 512A.

Using the example supra of FIG. 5, User A 608 may not navigate to the Easter City website through the hyperlink located within the Easter bunny advertisement 442. Consequently, the monitor module 112 may determine that that the value of the Easter bunny advertisement 442 to be low. The advertisement syndication server 108 may then recustomize the Easter bunny advertisement 442. The relevant modules of the advertisement syndication server 108 may recustomize the Easter bunny advertisement 442 following the steps illustrated in the example supra of FIG. 5. However, the relevant modules of the advertisement syndication server 108 may use the data obtained from analyzing tie λ′ in lieu of data obtained from analyzing tie λ.

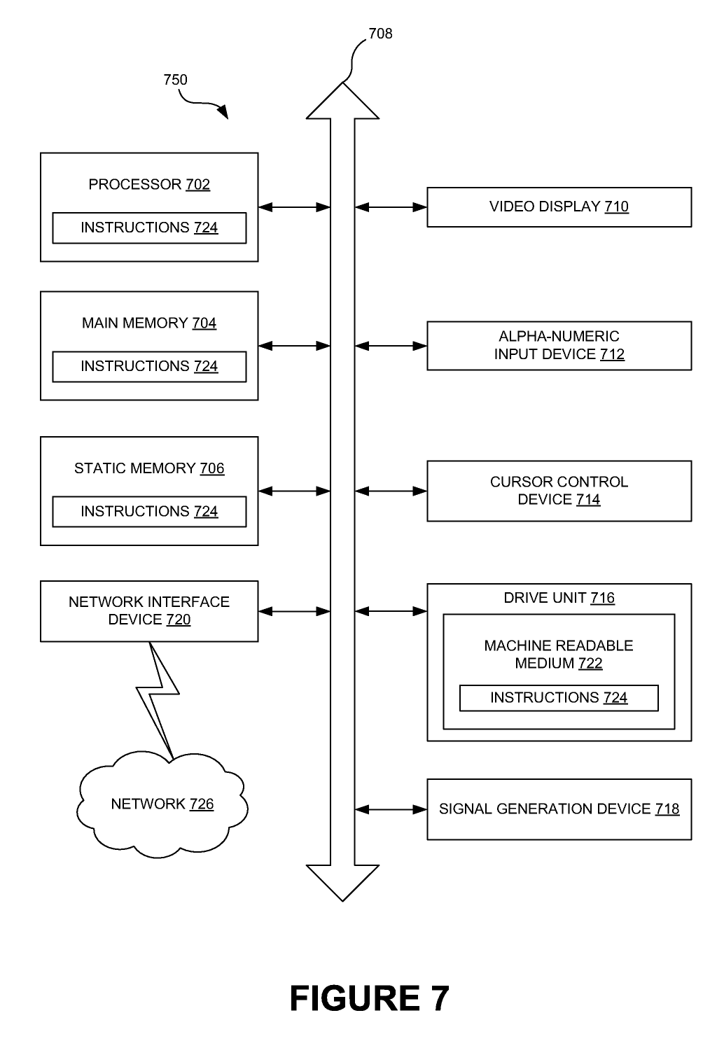

FIG. 7 is a diagrammatic system view of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or the data processing system in which one or more operations disclosed herein are performed. The processor 702 may be a microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically handicapped).

The cursor control device 714 may be a pointing device such as a mouse. The drive unit 716 may be the hard drive, a storage system, and/or other longer term storage subsystem. The signal generation device 718 may be a bios and/or a functional operating system of the data processing system. The network interface device 720 may be a device that performs interface functions such as code conversion, protocol conversion and/or buffering required for communication to and from the network 726. The machine readable medium 722 may provide instructions on which any of the methods disclosed herein may be performed. The instructions 724 may provide a source code or a data code to the processor 702 to enable any one or more of the operations disclosed herein.

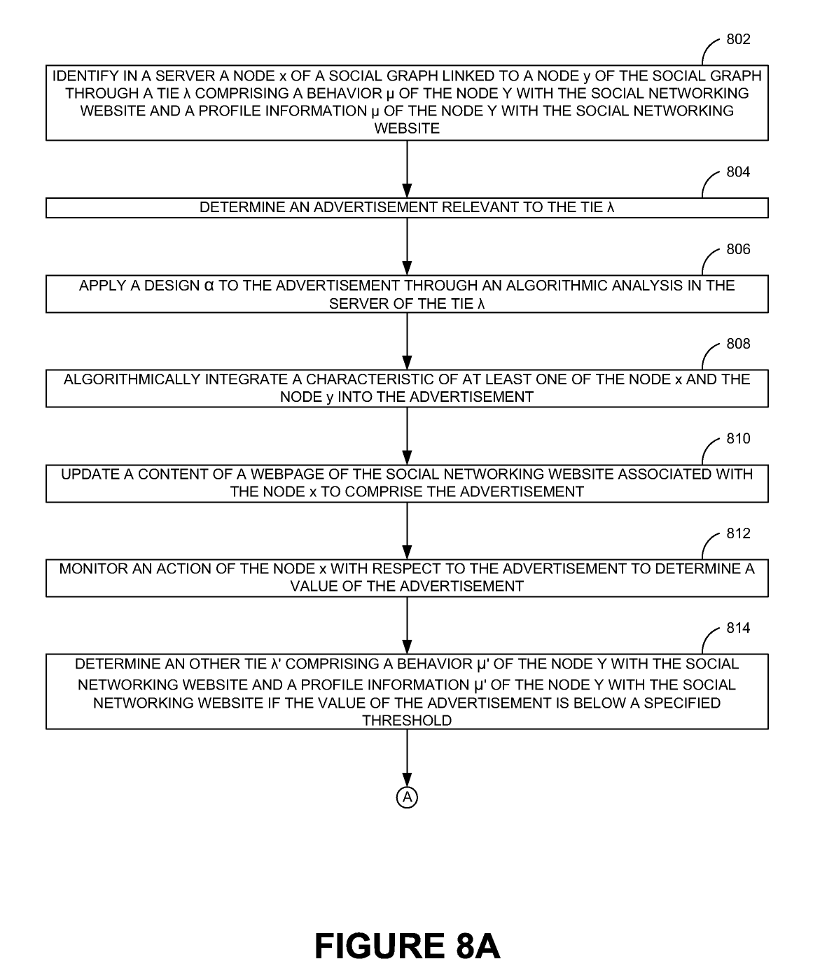

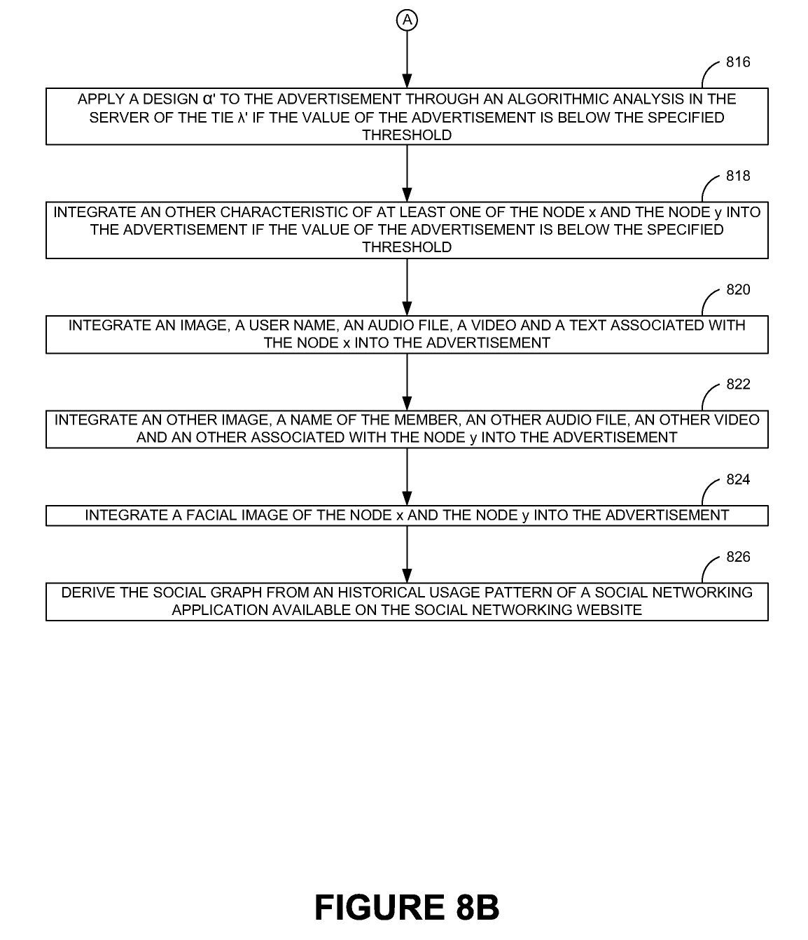

FIG. 8A is a process flow illustrating the identification of nodes and deriving the social graph from the record of usage available on the social networking website. In operation 802, in a server a node x of a social graph linked to a node y of the social graph may be identified through a tie λ comprising a behavior μ of the node y with the social networking website and a profile information μ of the node y with the social networking website. In operation 804, an advertisement relevant to the tie λ may be determined.

In operation 806, a design α may be applied to the advertisement through an algorithmic analysis in the server of the tie λ. In operation 808, a characteristic of the node x and the node y may be algorithmically integrated into the advertisement. In operation 810, a content of a webpage of the social networking website associated with the node x may be updated to comprise the advertisement. In operation 812, an action of the node x may be monitored with respect to the advertisement to determine a value of the advertisement.

In operation 814, another tie λ′ comprising a behavior μ′ of the node y with the social networking website and a profile information μ′ of the node y with the social networking website may be determined if the value of the advertisement is below a specified threshold, and wherein tie λ′ is relevant to the advertisement.

FIG. 8B is a continuation of process flow illustrated in FIG. 8A showing additional embodiments. In operation 816, a design α′ may be applied to the advertisement through an algorithmic analysis in the server of the tie λ′ if the value of the advertisement is below the specified threshold. In operation 818, another characteristic of the node x and the node y may be integrated into the advertisement if the value of the advertisement is below the specified threshold. In operation 820, an image, a user name, an audio file, a video and a text associated with the node x may be integrated into the advertisement.

In operation 822, another image, a name of the member, another audio file, and another video associated with the node y may be integrating into the advertisement. In operation 824, a facial image of the node x and the node y may be integrated into the advertisement. In operation 826, the social graph may be derived from an historical usage pattern of a social networking application available on the social networking website.

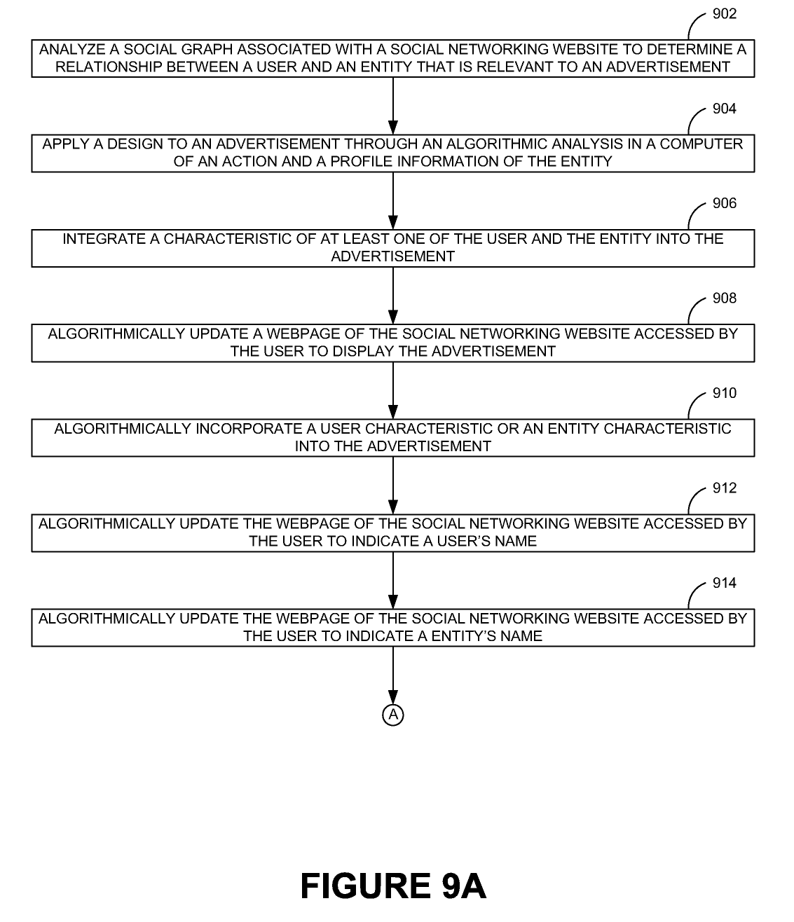

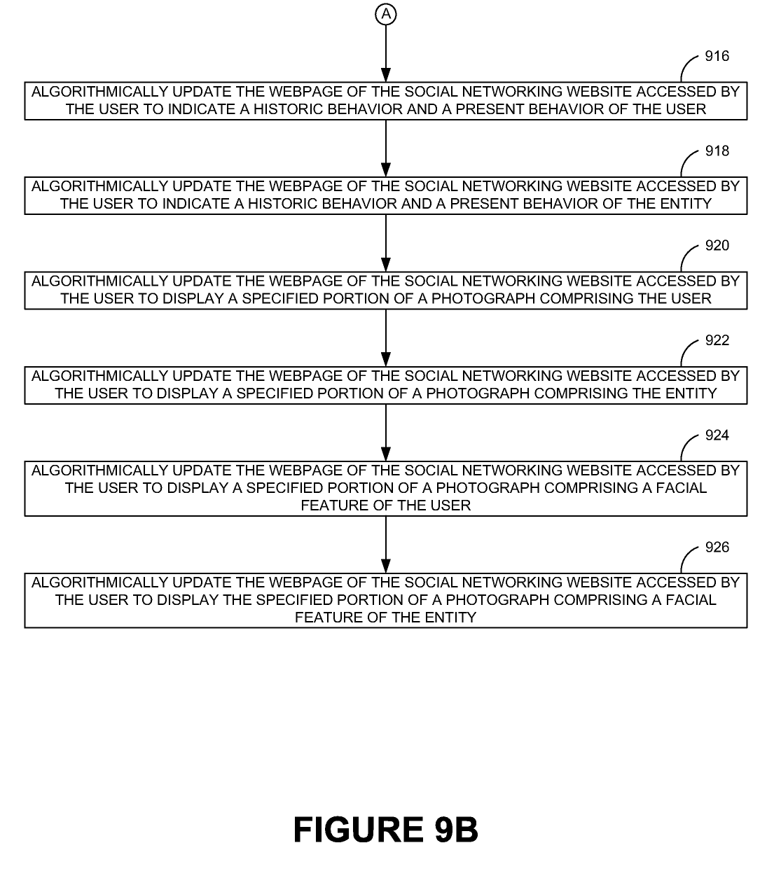

FIG. 9 is a process flow that illustrates analysis of a social graph associated with a social networking website and updating the webpage accessed by the user to indicate the various elements based on the social graph. In operation 902, a social graph associated with a social networking website may be analyzed to determine a relationship between a user and an entity that is relevant to an advertisement. The relationship may be based on an action and a profile information of the user or the entity. In operation 904, a design may be applied to an advertisement through an algorithmic analysis in a computer of an action and a profile information of the entity. In operation 906, a characteristic of at least one of the user and the entity may be integrated into the advertisement.

In operation 908, a webpage of the social networking website accessed by the user may be algorithmically updated to display the advertisement. In operation 910, a user characteristic and an entity characteristic may be algorithmically incorporated into the advertisement. In operation 912, the webpage of the social networking website accessed by the user may be algorithmically updated to indicate a user's name. In operation 914, the webpage of the social networking website accessed by the user may be algorithmically updated to indicate an entity's name.

FIG. 9B is a continuation of process flow illustrated in FIG. 9A showing additional embodiments. In operation 916, the webpage of the social networking website accessed by the user may be algorithmically updated to indicate a historic behavior and a present behavior of the user. In operation 918, the webpage of the social networking website accessed by the user may be algorithmically updated to indicate a historic behavior and a present behavior of the entity. In operation 920, the webpage of the social networking website accessed by the user may be algorithmically updated to display a specified portion of a photograph comprising the user.

In operation 922, the webpage of the social networking website accessed by the user may be algorithmically updated to display a specified portion of a photograph comprising the entity. In operation 924, the webpage of the social networking website accessed by the user may be algorithmically updated to display the specified portion of a photograph comprising a facial feature of the user. In operation 926, the webpage of the social networking website accessed by the user may be algorithmically updated to display the specified portion of a photograph comprising a facial feature of the entity.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry, firmware, software or any combination of hardware, firmware, or software embodied in a machine readable medium. For example, the various electrical structures and methods may be embodied using transistors, logic gates, application specific integrated (ASIC) circuitry or Digital Signal Processor (DSP) circuitry.

Particularly, the targeter module 110, the update module 114, the monitor module 112, and the customized advertisement feed module 128 of FIG. 1, the targeting module 200, the advertisement section module 222, the creative content module 206, and the integrator module 204 of FIG. 2, and the other modules may be enabled using software and/or using transistors, logic gates, and electrical circuits (e.g., application specific integrated ASIC circuitry) such as a targeter circuit, an update circuit, a monitor circuit, customized advertisement feed circuit, a targeting circuit, an advertisement section circuit, a creative content circuit, and an integrator circuit and other circuit.

In addition, it will be appreciated that the various operations, processes, and methods disclosed herein may be embodied in a machine-readable medium or a machine accessible medium compatible with a data processing system, and may be performed in any order. Accordingly, the Specification and Drawings are to be regarded in an illustrative rather than a restrictive sense.

What is claimed is:

1. A computer-implemented method of online marketing comprising:
identifying in a server a node x of a social graph linked to a node y of the social graph through a tie λ comprising a behavior μ of the node y with a social networking website and a profile information μ of the node y with the social networking website;
determining an advertisement relevant to the tie λ;
applying a design α to the advertisement through an algorithmic analysis in a server of the tie λ;
algorithmically integrating a characteristic of the node y into the advertisement;
updating a content of a webpage of the social networking website associated with the node x to comprise the advertisement;
monitoring an action of the node x with respect to the advertisement to determine a value of the advertisement;
determining an other tie λ′ comprising a behavior μ′ of the node y with the social networking website and a profile information μ′ of the node y with the social networking website if the value of the advertisement is below a specified threshold, and wherein tie λ′ is relevant to the advertisement;
applying a design α′ to the advertisement through an algorithmic analysis in the server of the tie λ′ if the value of the advertisement is below the specified threshold; and
integrating an other characteristic of the node y into the advertisement if the value of the advertisement is below the specified threshold.

2. The method of claim 1 further comprising:
integrating at least one of an image, a user name, an audio file, a video and a text associated with the node y into the advertisement.

3. The method of claim 2 further comprising:
integrating at least one of an other image, a name of the member, an other audio file, an other video and an other associated with the node x into the advertisement.

4. The method of claim 2 further comprising:
integrating a facial image of the node y into the advertisement.

5. The method of claim 1 further comprising:
deriving the social graph from an historical usage pattern of a social networking application available on the social networking website.

6. The method of claim 1, wherein a machine is caused to perform the method of claim 1 when a set of instructions in a form of a machine-readable medium is executed by the machine.

7. A computer-implemented method of online marketing comprising:
analyzing a social graph associated with a social networking website to determine a relationship between a user and an entity that is relevant to an advertisement;
applying a design to an advertisement through an algorithmic analysis in a computer of at least one of an action and a profile information of the entity;
integrating a characteristic of the entity into the advertisement; and
algorithmically updating a webpage of the social networking website accessed by the user to display the advertisement.

8. The method of claim 7, wherein the relationship comprises at least one of an action and a profile information of the entity.

9. The method of claim 8 further comprising:
algorithmically updating the webpage of the social networking website accessed by the user to indicate an entity's name.

10. The method of claim 9 further comprising:
algorithmically updating the webpage of the social networking website accessed by the user to indicate at least one of a historic behavior and a present behavior of the entity.

11. The method of claim 10 further comprising:
algorithmically updating the webpage of the social networking website accessed by the user to display a specified portion of a photograph comprising the entity.

12. The method of claim 10 further comprising:
algorithmically updating the webpage of the social networking website accessed by the user to display the specified portion of a photograph comprising a facial feature of the entity.

13. The method of claim 12,
wherein the characteristic is an image associated the entity, a text associated with the entity, an audio file associated with the entity, and a video associated with the entity, and
wherein the relationship comprises at least one of an other action and an other profile information of the user.

14. The method of claim 13 further comprising;
algorithmically updating the webpage of the social networking website accessed by the user to indicate a user's name and to include an image of the user.

15. A system of a advertisement syndication server comprising:
an advertisement syndication server;
a social graph analyzer communicatively coupled with the advertisement syndication server to identify a node x of a social graph linked to a node y of the social graph through a tie λ comprising at least one of a behavior μ of the node y associated with the social networking website and a profile information μ of the node y associated with the social networking website;
a targeter module communicatively coupled with the advertisement syndication server to determining an advertisement relevant to the tie λ;
a design creator communicatively coupled with the advertisement syndication server to apply a design α to the advertisement through an algorithmic analysis of the tie λ;
an advertisement configurator communicatively coupled with the advertisement syndication server to algorithmically integrating a characteristic of at least one of the node x and the node y into the advertisement; and
an update module communicatively coupled with the advertisement syndication server to update a content of a webpage of the social networking website associated with the node x to comprise the advertisement.

16. The system of claim 15 further comprising:
a monitor module communicatively coupled with the advertisement syndication server to monitor an action of the node x with respect to the advertisement to determine a value of the advertisement,
wherein the social graph analyzer determines an other tie λ′ comprising at least one of a behavior μ′ of the node y with the social networking website and a profile information μ′ of the node y with the social networking website if the value of the advertisement is below a specified threshold, and wherein the tie λ′ is relevant to the advertisement,
wherein the design creator applies a design α′ to the advertisement through an algorithmic analysis of the tie λ′ if the value of the advertisement is below the specified threshold, and
wherein the advertisement configurator integrates an other characteristic of at least one of the node x and the node y into the advertisement if the value of the advertisement is below the specified threshold.

17. The system of claim 16,
wherein the characteristic is at least one of an image, a user name, an audio file, a video and a text associated with the node y, and
wherein tie λ comprises a behavior β of the node x with a social networking website, a profile information β of the node x with the social networking website, and
wherein tie λ′ comprises a behavior β′ of the node x with the social networking website, a profile information β′ of the node x with the social networking website.

18. The system of claim 17, wherein the characteristic is at least one of an image, a user name, an audio file, a video and a text associated with the node x.

19. The system of claim 17, wherein the characteristic comprises a facial image of the node y into the advertisement.

20. The system of claim 16, wherein the social graph analyzer derives the social graph from an historical usage pattern of a social networking application available on the social networking website.
